(19) United States
(12) Patent Application Publication
(10) Pub. No.: US 2012/0150881 A1
(43) Pub. Date: Jun. 14, 2012

(54) CLOUD-HOSTED MULTI-MEDIA APPLICATION SERVER

(76) Inventors: Seong Hyeon Cho, Nepean (CA); Sergey Pervoi, Ottawa (CA); Stephen Nelson West, Ottawa (CA); Christopher John Carfagnini, North Bay (CA)

(21) Appl. No.: 12/964,425

(22) Filed: Dec. 9, 2010

(51) Int. Cl. G06F 17/30; G06K 9/00

(52) U.S. Cl. 707/755; 382/100; 707/E17.005

(57) ABSTRACT

The invention is directed to a method and system for automatically processing multimedia files in a cloud-based multi-media application server. The processing comprises parsing metadata from the multimedia files and automatically generating a description. The system comprises a file system, a content detector; and a content processor.

### FIELD OF THE INVENTION

The invention is directed to wireless data communication systems, and in particular to a system for automated access to photos and video.

### BACKGROUND OF THE INVENTION

Today, professional photographers and others such as first responders, insurance adjusters, real estate agents, and other professionals who use professional-grade photographic equipment to capture information, evidence, or commercial images are limited in their ability to transfer photos, video, and metadata quickly from remote locations. The transfer of such data typically requires a WiFi zone or a fixed broadband connection, the access to which may be some distance from the scene of the photograph. This limitation costs the photographer time and money.

In addition, professional tools for processing images and video, workflow management, and publication of digital media are often limited to software applications that run on laptops used by individual photographers or on workstations with locally installed or client/server-based applications that are available only from the publishing office Local Area Network (LAN). The support of such infrastructure is expensive and inefficient—especially if there is a large pool of users in the field, or if the data requires complex, multi-site processing.

Therefore, a means for automatically receiving and processing images, video and audio would be highly desirable.

### SUMMARY OF THE INVENTION

One aspect of an embodiment of the present invention provides a method of automatically processing multimedia files in a cloud-based multi-media application server. The method comprises steps of: receiving at the application server, a multi-media file; responsive to the receiving step, processing the multi-media file; storing the processed multi-media file in a database for access by authorized users of the application server, wherein the processing comprises parsing metadata embedded in the multimedia file.

In some embodiments of the invention the receiving step comprises receiving using an FTP (File Transfer Protocol) server.

In some embodiments of the invention the receiving step further comprises capturing a user ID (identifier) associated with the multi-media file.

In some embodiments of the invention the step of processing the multi-media file comprises reverse geocoding location coordinates to a location label.

In some embodiments of the invention the location label comprises a street address.

In some embodiments of the invention the step of processing comprises a step of automatically generating a description from metadata parsed from the multi-media file.

In some embodiments of the invention the step of generating a description further comprises using a user ID (identifier) associated with the multi-media file.

In some embodiments of the invention the step of generating a description further comprises incorporating user information pre-populated on a database correlated with the user ID.

Some embodiments of the invention further comprise a step of sending a notification to a pre-registered contact list.

In some embodiments of the invention the notification comprises a copy of the multimedia file.

Some embodiments of the invention further comprise a step of generating a thumbnail image from an image or video frame if available, of the multi-media file.

Some embodiments of the invention further comprise a step of storing the thumbnail image in the database.

In some embodiments of the invention the multi-media file has a format selected from one of the following types: JPEG (Joint Photographic Experts Group) image file; Raw (camera raw image file); WAV (Waveform Audio file format) audio file MP3 (Moving Picture Experts Group (MPEG)-1 or MPEG-2, Audio Layer 3) audio file; and MOV (QuickTime or MP4 (MPEG-4)) video.

In some embodiments of the invention the processed multi-media file comprises a JPEG (Joint Photographic Experts Group) image file, then overlaying a predefined overlay watermark to the image file.

Another aspect of an embodiment of the present invention provides an automated cloud-hosted multi-media application server comprising; a file system for receiving and managing files; a content detector for detecting multi-media files received by the file system; and a content processor responsive to the content detector for automatically processing the multi-media files and storing the multi-media files in a database for access by authorized users of the application server, wherein the processing comprises parsing metadata embedded in the multimedia file.

Another aspect of an embodiment of the present invention provides a program storage device readable by a machine, tangibly embodying a program of instructions executable by the machine to perform the method steps described above.

### BRIEF DESCRIPTION OF THE DRAWINGS

Some embodiments of apparatus and/or methods in accordance with embodiments of the present invention are now described, by way of example only, and with reference to the accompanying drawings in which:

FIG. 1 illustrates a network configuration for an embodiment of the present invention; and

FIGS. 2A and 2B illustrate method of processing multimedia files according to an embodiment of the present invention.

In the figures, like features are denoted by like reference characters.

### DETAILED DESCRIPTION

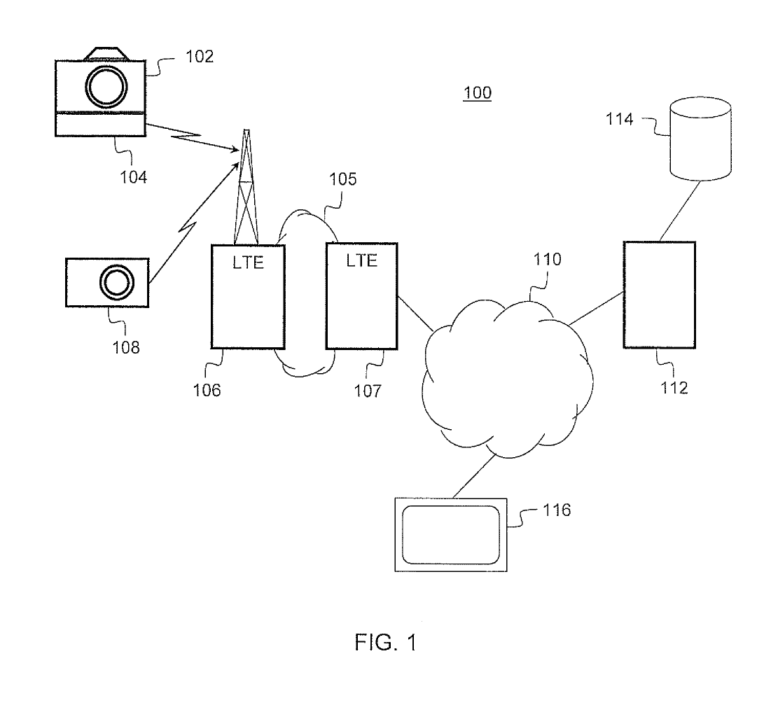

Referring to FIG. 1, network configuration 100 takes advantage of the speed and low latency of LTE (Long Term Evolution) broadband wireless network 105 having LTE nodes 106 and 107. The LTE network is a step toward the 4th generation of cellular radio technologies that are designed to increase the capacity and speed of mobile telephone networks. The LTE network provides the potential for downlink peak rates of 100 Mb/s or more, uplink peak rates of 50 Mb/s or more, and RAN (Radio Access Network) round-trip times of 10 ms or less.

Camera 102 can capture images, audio and video and is equipped with an LTE radio interface adapter 104 which can transmit image, audio and video files created by camera 102 via node 106. Camera 108 has an LTE interface incorporated directly in the camera, resulting in capabilities similar to camera 102 and adapter 104. Image, audio and video files created by cameras 102 and 106 can be transmitted by their respective LTE interfaces to LTE node 106 and forwarded via LTE network 105 through LTE node 107 to the Internet 110 (“The cloud” or interconnected networks) to multi-media application server 112, which is configured to receive multimedia files automatically and store them in database 114. Multi-media application server 112 is configured to receive multimedia files automatically, process them for publication automatically and store them in database 114. Multi-media application server 112 also acts as a server to make these multimedia files available to users at computer display 116 via Internet 110.

This system is well suited to a variety of different service models such as: enterprise and professional; public sector; and consumer. An enterprise service model could be set up to serve photographers for: news agencies, news publishers, new media agencies, stock photo services; to serve inspectors and claims adjusters for insurance companies; to serve listing agents for real estate agencies; to serve medical and dental professionals for medical and dental institutions; to serve students and staff for educational institutions, etc. A professional service model could be set up to serve professional photographers. A consumer service model could be set up to serve consumers for uploading and storage of photos automatically, for instant photo processing and printing, for wearable personal security; for automatic uploading to social networking services, live event sharing, etc.

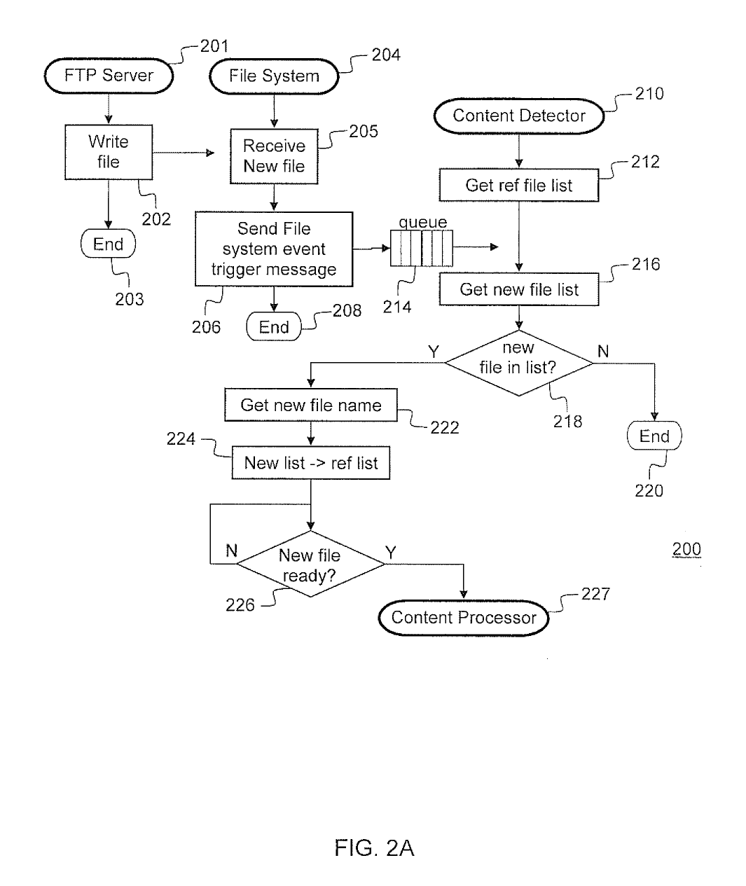

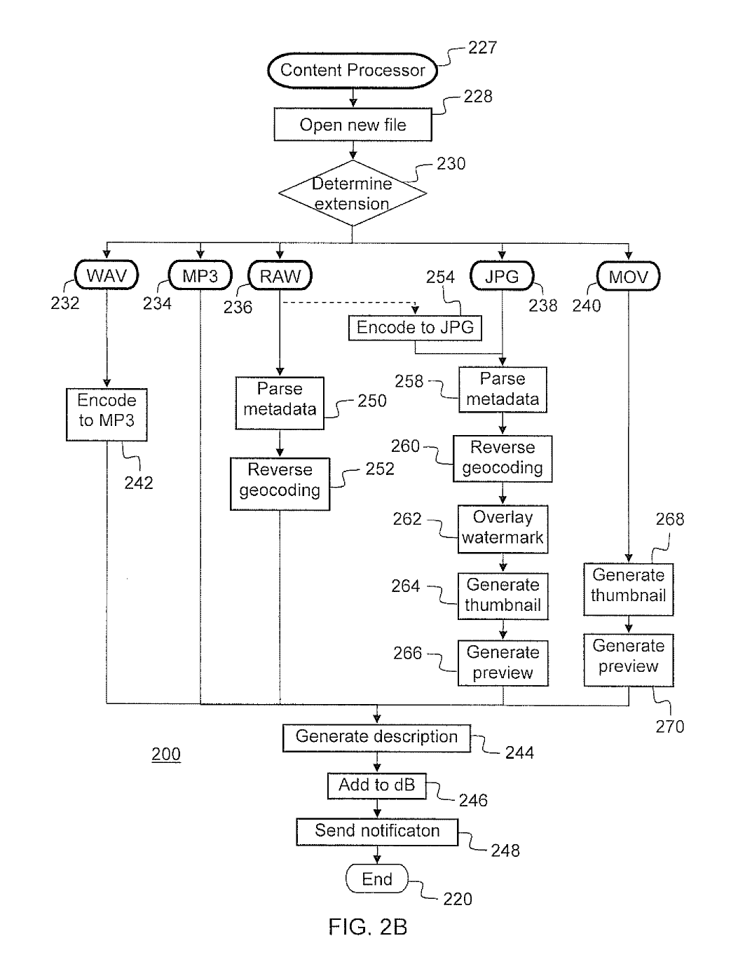

With reference to FIGS. 2A and 2B, the process 200 executes on multi-media application server 112. Process 200 has four main sub processes, an FTP (File Transfer Protocol) Server process 201, a File System process starting at step 204, a Content Detector process starting at step 210, and a Content Processor process starting at step 227.

FTP Server process 201 running on multi-media application server 112 receives a multimedia files from an FTP client process on camera 102, or adapter 104 on camera 106. At step 202 the FTP Server process writes the incoming file is to file system of multi-media application server 112. In one embodiment, the FTP Server process also captures a user ID associated with the FTP client process and stores this information on the file system. At step 203 the FTP Server process ends. At step 205 the File System process receives the new file and at step 206 sends a file system event trigger message to file system event queue 214. The event trigger message can be a File Alteration Monitor (FAM) signal in UNIX or an inotify or dnotify signal in Linux or a similar event to indicate a change in the file system. Note that these triggers are typically generated for several types of changes to the file system, including adding a file, deleting a file, modifying a file, etc. The File System process ends at step 208.

Content Detector process 210 initializes at step 212 by reading the file directory of the file system to obtain a reference file list. As file system event triggers are received at event queue 214, the Content Detector process is triggered to read the file directory at step 216 to get a new file list. At step 218, the reference file list and the new file list are compared to determine if a new file has been received in which case, at step 222 the file name of the new file is retrieved. Note that if multiple files are new, the system will perform the following steps on each of the new files. At step 224 the reference file list is updated with the files of the new file list to reflect the current status of the directory. At step 226 the system determines if the new file is ready to be used. The system determines if the file is closed as an indication that the file is not currently being altered or written to. In some embodiments the system can retrieve the file size, wait a predetermined period of time, for example one second, and retrieve the file size again to determine if the file size is stable which can help ensure that the file is not being written to sporadically, between periods of being closed. If the file is not ready step 226 is repeated until the file is ready. Once the new file is ready to be read, the Content Detector process initiates the Content Processor process 227.

The Content Processor process 227 starts at step 228 the Content Processor process opens the new file and at step 230 determines the file type by reading the file extension. In some embodiments the file type is determined by analyzing the file header format. Supported multimedia file types include but are not limited to: image files such as JPEG (Joint Photographic Experts Group) and Raw (camera raw image file); audio files such as WAV (Waveform Audio file format) and MP3 (Moving Picture Experts Group (MPEG)-1 or MPEG-2, Audio Layer 3); or video files such as MOV (QuickTime or MP4 (MPEG-4)).

If at step 230, the new file is determined to be a WAV audio file, the process is directed to WAV routine 232 and at step 242 the WAV audio file is encoded/compressed to MP3 audio file format and then at step 244 a description of the file is automatically generated from available and parsed metadata and other data associated with the file. Metadata can include picture date/time, camera model and manufacturer, exposure time/mode/program, F-number, ISO speed, focal length, flash on/off, white balance mode, size, author/photographer name, copyright information, GPS location, etc. Other data can include a location address or label derived from reverse geocoding GPS coordinates, or derived from a database look up of a subscriber name or user ID associated with the FTP client of camera 102 or LTE radio interface adapter 104. The user ID can be correlated with user information pre-populated on database 114, including user name, address and other information. At step 246 the new file is added to database 114. Once loaded on the database, the file is available to subscribers or authorized users of multi-media application server 112, using conventional file server techniques well known to persons of skill in the art. In some embodiments, at step 246, the process sends notification to a pre-registered contact list, advising that a new multimedia file is available. The contact list can include one or more email addresses, another machine(s), or another application(s) accessible through the Internet (“The cloud”) 110. Notification can take the form of an email, text message, or other electronic message format. In this manner, notification could be sent to a news editor awaiting breaking news photos from a photographer or to a subscriber awaiting multimedia files matching specific search criteria such as a key word in the description, a specific photographer, a specific location, etc., of the file added to database 114.

In other embodiments, at step 248, the process sends the processed file itself to the pre-registered contact list. If at step 230, the new file is determined to be an MP3 audio file, the process is directed to MP3 routine 234 which proceeds directly to step 244 as described previously.

If at step 230, the new file is determined to be a Raw image file, the process is directed to RAW routine 236. At step 250 the process parses the metadata of the image file which is used in later steps. The metadata can include picture date/time, camera model and manufacturer, exposure time/mode/program, F-number, ISO speed, focal length, flash on/off, white balance mode, size, author/photographer name, copyright information, GPS location, etc. At step 252, the process reverse geocodes the location information parsed from the image file as GPS latitude and longitude coordinates. In one embodiment, the GPS latitude and longitude coordinates are transmitted to a mapping utility such as for example, Google maps (maps.google.com), operated by Google Inc. The location address is then retrieved from the mapping utility. Some mapping utilities can also retrieve a label or name for well-known landmarks at a specific location or address. If available, such a label is also retrieved. The process then continues to step 244 where the parsed metadata, retrieved location address is used to automatically generate a description of the file as described previously. In some embodiments, the Raw image file is also encoded/compressed to JPEG image format at step 254. The process then follows the JPG routine 238 at step 258, described below.

If at step 230, the new file is determined to be a JPEG image file, the process is directed to JPG routine 238 which starts at step 258 where the process parses the metadata of the image file which is used in later steps. The metadata can include picture date/time, camera model and manufacturer, exposure time/mode/program, F-number, ISO speed, focal length, flash on/off, white balance mode, size, author/photographer name, copyright information, GPS location, etc. At step 260, the process reverse geocodes the location information parsed from the image file as GPS latitude and longitude coordinates as described in step 252. At step 262, a predefined overlay watermark is applied to the JPEG image. The overlay watermark could be a logo or a copyright notice for marketing purposes or to prevent or discourage unauthorized copying of the image if it will be made widely available such as by publishing on a public website. At step 264 a thumbnail image is generated. A thumbnail image is a greatly reduced image size having a commensurately reduced file size useful as an index image and suitable for displaying multiple images on a user interface such as a display on a mobile telephone, a computer display, or other user display. In some embodiments, an embedded EXIF (Exchangeable image file format) thumbnail image is extracted from the metadata of the JPEG image file. At step 266 a preview image is generated. A preview image is a reduced size image having a reduced file size, optimized for viewing on a user interface. The process then continues to step 244 described previously. Note that at step 246, when the new file is added to database 114, the thumbnail image file generated at step 264 and the preview image file generated at step 266 are also added to database 114. In some embodiments, the thumbnail image file is stored in a separate thumbnail directory and the preview image file is stored in a separate preview image directory.

If at step 230, the new file is determined to be a MOV video file, the process is directed to MOV routine 240. At step 268, a thumbnail image representative of the video file is generated. In some embodiments, the first frame of the video file is captured and converted to a thumbnail-size JPEG image file. At step 270, a preview image corresponding to the thumbnail image is generated. The thumbnail image generated at step 268 and the preview image generated at step 270, are useful for representing the video file to a user when displayed in a directory listing context. The process then continues to step 244 as described previously.

Advantages of the present invention can include speed of processing multimedia files and especially in the case of multiple multi-media files, the consequent high volume capability (automatically and without human intervention). This becomes even more important with the introduction of LTE and other high speed and high bandwidth mobile communications systems and the inevitable increase in number of resolution still image and video cameras with built-in high speed communication capability. Other advantages may include improved accuracy of receipt-time logging of photos and multimedia files because they are processed on an interrupt-driven basis, thus processed quickly and with delays related to human intervention and because of the uniformity of processing operation for a given user profile and file type. The advantages of the cloud-based location of the application server relieves users from maintaining a computer and related software and performing repetitious workflow actions on multi-media files to make them available to clients, editors, other users, social networking services, etc.

A person of skill in the art would readily recognize that steps of various above-described methods can be performed by programmed computers. Herein, some embodiments are also intended to cover program storage devices. e.g., digital data storage media, which are machine or computer-readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Numerous modifications, variations and adaptations may be made to the embodiment of the invention described above without departing from the scope of the invention, which is defined in the claims.

1. A method of automatically processing multimedia files in a cloud-based multi-media application server, the method comprising steps of:
receiving at said application server, a multi-media file;
responsive to said receiving step, processing said multi-media file;
identifying a user identifier (ID) associated with the received multimedia file, wherein the user ID is associated with a social networking account;
storing the processed multi-media file in a database in association with the social networking account for access by authorized users of said application server,
wherein said processing comprises parsing metadata embedded in said multimedia file.

2. The method of claim 1, wherein said receiving step comprises receiving using an FTP (File Transfer Protocol) server.

3. (canceled)

4. The method of claim 1, wherein the step of processing said multi-media file comprises reverse geocoding location coordinates to a location label.

5. The method of claim 4, wherein said location label comprises a street address.

6. The method of claim 1, wherein said step of processing comprises a step of automatically generating a description from metadata parsed from said multi-media file.

7. The method of claim 6, wherein said step of generating a description further comprises using a user ID (identifier) associated with said multi-media file.

8. The method of claim 7, wherein said step of generating a description further comprises incorporating user information pre-populated on a database correlated with said user ID.

9. The method of claim 1 further comprising a step of sending a notification to a pre-registered contact list, wherein the pre-registered contact list is associated with the social networking account.

10. The method of claim 9, wherein said notification comprises a copy of said multimedia file.

11. The method of claim 1 further comprising a step of generating a thumbnail image from an image or video frame if available, of said multi-media file.

12. The method of claim 11, further comprising a step of storing said thumbnail image in said database.

13. The method of claim 1 wherein said multi-media file has a format selected from one of the following types: JPEG (Joint Photographic Experts Group) image file; Raw (camera raw image file); WAV (Waveform Audio file format) audio file MP3 (Moving Picture Experts Group (MPEG)-1 or MPEG-2, Audio Layer 3) audio file; and MOV (QuickTime or MP4 (MPEG-4)) video.

14. The method of claim 1, wherein if said processed multi-media file comprises a JPEG (Joint Photographic Experts Group) image file, then overlaying a predefined overlay watermark to said image file.

15. An automated cloud-hosted multi-media application server comprising:
a file system for receiving and managing files;
a content detector for detecting multi-media files received by said file system; and
a content processor responsive to said content detector for:
automatically processing said multi-media files, wherein said processing comprises identifying at least one user identifier (ID) associated with the received multi-media files, wherein the at least one user ID is associated with a social networking account, and
storing said multi-media files in a database in association with the social networking account for access by authorized users of said application server.

16. A program storage device readable by a machine, tangibly embodying a program of instructions executable by the machine to perform the method steps of claim 1.

17. A multimedia capture device for automatically uploading multimedia files to a multimedia server, the multimedia capture device comprising:
capture hardware configured to generate multimedia content;
a mobile interface configured to communicate with the multimedia server via a mobile carrier network; and
a processor configured to, in response to the generation of the multimedia content, automatically transmit the multimedia content to the multimedia server via the mobile interface.

18. The multimedia capture device of claim 17, wherein:
the multimedia capture device is configured with a user identifier (ID) associated with a social networking account, and
the processor is further configured to transmit the user ID associated with the social networking account along with the multimedia content to the multimedia server via the mobile interface.

19. The multimedia capture device of claim 17, wherein the mobile carrier network is a long term evolution (LTE) network.

20. The multimedia capture device of claim 17, wherein:
the processor is further configured to transmit location information along with the multimedia content to the multimedia server via the mobile interface.

21. The method of claim 1, wherein the multi-media application server hosts a social networking service.
